(19) United States
(12) Patent Application Publication
(10) Pub. No.: US 2022/0323935 A1
(43) Pub. Date: Oct. 13, 2022

(54) Covalent-Organic Framework Materials and Methods of Making Thereof

(71) Applicant: Cambridge Enterprise Limited, Cambridge (GB)

(72) Inventors: David Fairen-Jimenez, Cambridge (GB); Mark Egdell Carrington, Cambridge (GB)

(21) Appl. No.: 17/641,055

(22) PCT Filed: Sep. 15, 2020
(86) PCT No.: PCT/EP2020/075779

§ 371 Date: Mar. 7, 2022

(30) Foreign Application Priority Data
Sep. 16, 2019 (GB) 1913355.2

(51) Int. Cl. B01J 20/28; B01J 20/30; B01J 20/22; B01D 53/04

(52) U.S. Cl. CPC B01J 20/28004; B01J 20/28007; B01J 20/28011; B01J 20/3078; B01J 20/3028; B01J 20/3085; B01J 20/3071; B01J 20/22; B01D 53/04; B01D 2253/20

(57) ABSTRACT

The present invention provides a covalent-organic framework (COF) body, populations of such bodies, a method for manufacturing a covalent-organic framework (COF) body, and (a) a gas storage system or a gas separation system comprising a gas storage vessel and a population of such COF bodies. The COF body comprises a plurality of primary COF particles, some or all of the primary COF particles being agglomerated as COF agglomerates. The average diameter of the primary COF particles is between nm and 120 nm, and the average diameter of the agglomerates is larger than the average diameter of the primary COF particles and between 15 nm and 250 nm. By careful control over particle size distribution during the formation of the COF material, it is possible (b) to form COF materials into high bulk density shapes and forms which are industrially useful and practical without losing sorbent performance.

### FIELD OF THE INVENTION

The present invention relates to covalent-organic framework materials and particularly, although not exclusively, to bodies formed from covalent-organic framework materials and methods of making thereof, which may find particular application in industrial applications including gas storage, gas separation, liquid separation, ion transport, electronics and energy storage.

### BACKGROUND

Porous materials can be used to adsorb and store a wide range of substances, for example gases, ions and small molecules. Such materials are of great interest commercially, as materials with high surface areas and porosities can be used to store large volumes of substances, especially gases, at relatively low pressures. The ability to store large quantities of gases, such as hydrogen, methane and carbon dioxide, at lower pressures than is currently possible and in pressurized gas vessels of reasonable size is crucial to the economic and practical viability of the widespread adoption of alternative fuel sources. The aspect of storage vessel size is very important for many applications, such as road transport where available volume is limited, for example in applications such as hydrogen-powered vehicles, as well as in applications such as the removal of toxic substances, the storage and transport of energy dense fuels, the efficient operation of portable electronic devices, the capture of greenhouse gases, and the separation of target substances from a mixed feed.

Accordingly, research into highly sorbent and porous materials is widespread. Materials such as zeolites, activated carbons and metal-organic frameworks materials have been extensively investigated for their ability to sorb gases. Such sorbents are often used in processes such as pressure swing gas purification. The IPC class F17C 11/007, for example, covers the use of gas-sorbents in hydrocarbon storage systems. However, their performance is limited and insufficient for future, more demanding requirements.

Industrial requirements are very often best served by sorbent materials which have the highest practical gas storage capacities. In recognition of the crucial importance of high-performance gas sorbents, the US Department of Energy (DoE) has set ambitious industry targets for some gases, including methane and hydrogen. To date, no commercially available sorbent can meet these standards. There has therefore been on-going and continuous work to develop materials with higher gas storage properties per unit of volume. This is important because available storage volume is limited in many applications, for example transport. Work can be done on either improving the bulk density of materials whilst maintaining sorption capacity or developing newer chemistries with better sorption properties. Ideally, both are done simultaneously.

In recent years, there has been much focus on a novel class of crystalline materials called metal-organic frameworks or MOFs. These materials are made up of metal ions which are bonded together by organic linker molecules using coordination chemistry. These materials can have very high surface areas. However, a common problem with such materials is their low chemical stability. They can rapidly lose their molecular structure and efficacy, for example when exposed to water or other species which often occur as contaminants in industrial gases. This low stability has driven developments of more stable species of MOF. However, stability, or lack of, continues to be a fundamental issue for many MOF materials. High performance test results are often reported which are based on laboratory conditions which are not representative of industrial conditions or industrial quality materials. Many sorbent materials including MOFs, zeolites and other such materials are typically synthesised as fine powders. However, powders are not always a convenient form for industrial use. For example, if fine powders are loaded directly into large gas storage vessels, the fine powder may be compacted by the pressure of the incoming gas and block the flow of gas into and out of the vessel. Additionally, use of a fine powder may increase the amount of work needed to pump a gas into the storage vessel. Furthermore, use of fine powders may also affect the time taken to achieve the rated storage pressure, as equilibration times are longer for packed vessels employing finer particles.

The material may have a very high sorption capacity, but if gas cannot be loaded and removed from the storage vessel sufficiently rapidly, then the system is not useful.

To deal with this, finer sorbent powdered materials are often formed into larger shaped bodies, e.g. tablets, pellets or beads which are then loaded into a storage vessel. Such shaped bodies are sometimes referred to as ‘monoliths’ in the field. When a population of such pellets/beads is placed inside a storage vessel, interstitial gaps will be present around the pellets/beads which thereby allows for more facile ingress and egress of gas. The need to store as much gas as possible in a storage vessel of given volume means that the density, e.g. bulk or envelope densities, of the sorbent bodies is extremely important. The higher the density, the more material can fit into the available working volume. If the bulk or envelope density of a sorbent bead or particle is too low, then the amount of sorbent material that can be placed inside the storage vessel is limited, thus leading to limited gas storage. Accordingly, shaped bodies are often formed by compaction, or are subsequently compacted to increase the bulk density of the shaped bodies by reducing or eliminating unwanted interstitial macropores—macro-porosity being defined as pores of greater than about 50 nm diameter which are formed between particles of the sorbent materials. Such macro-pores do not significantly contribute to the sorption capacity and reduce the bulk density, and furthermore can reduce the mechanical strength of the shaped bodies.

However, the use of compressive techniques to increase mechanical strength and reduce macro-porosity can also be disadvantageous in that it may result in the collapse and elimination of smaller-scale porosity within the shaped body. For example, it may result in the collapse of some or all of the micropores of the sorbent material, micro-porosity being defined as pores of less than about 2 nm diameter. Micro-pores may contribute heavily to gas storage capacity of a material (in comparison to macro-pores) and so collapse of these micro-pores should ideally be reduced or avoided. Compaction processes may in some cases therefore lead to a reduction in sorption capacity of the material per unit mass.

An alternative method of forming shaped bodies is by extrusion. In extrusion processes, a sorbent material powder is mixed with one or more liquid materials to form a dough or paste and is subsequently extruded and cut or otherwise shaped to form bodies. The shaped bodies are then dried to remove some of the liquid. However, such processes often have a number of disadvantages. For example, the pressures applied during processing can cause internal pores to collapse, thereby lowering the performance of the product. Furthermore, shaped bodies produced by such processes often have relatively high macroporosity and lower bulk density, as a result of the large amounts of liquid typically needing to be added to form an extrudable dough and consequent need to remove a relatively large proportion of the composition (the liquid fraction) from the dough by drying, leaving large gaps and a lower density material.

It would be desirable to be able to create a shaped body which combines good sorbent properties including high surface area with other desirable properties, such as good bulk density.

The present invention has been devised in light of the above considerations.

### SUMMARY OF THE INVENTION

The present inventors have realised that a promising class of sorbent materials are so-called covalent-organic framework (COF) materials. These are classes of materials that have structures created mostly or completely by covalent bonds using light, non-metallic elements such as carbon, nitrogen, hydrogen, oxygen, boron, silicon, phosphorus and sulphur. There are some similarities in porous structure to metal-organic framework materials, but generally the chemistry and resulting structures, properties and behaviours are different to MOFs, and accordingly, manufacturing and processing conditions used for the manufacture of MOF materials are not necessarily applicable to manufacture and production of COF materials.

Due to the strength of the covalent bonds, some COFs can display high levels of chemical stability. This makes them highly interesting as gas storage materials. COFs can contain structures which are fundamentally 2-D (like graphite) or 3-D (like diamond). The distinction between 2-D and 3-D structures is a fundamental difference between COFs, especially for their physical stability. They can be synthesised under realistic and practical mild conditions under a variety of techniques including solution-based and mechano-synthetic routes. This is in contrast to MOF materials, which are bonded together by coordinative linkages, and thus generally have far lower levels of chemical stability.

COF materials may be produced by solution-based synthesis routes. These processes typically result in production of fine powders. Accordingly, whilst having high chemical stability and gas sorption capacity, COF materials suffer from the same issues in large-scale use as other fine powdered materials, as discussed above. In particular, COF materials typically have low mechanical strength compared to other sorbent materials. This is especially true for 2-D COFs. The graphite-like stacked sheet structure of most 2-D COFs means that they are especially susceptible to shear deformation as the COF sheets slide over each other. This makes processing of 2-D COFs by processes involving shear, eg extrusion, especially challenging. Accordingly, the problems discussed above relating to compressive techniques for forming shaped bodies are particularly problematic for COF materials; indeed it has been found that COF materials formed into bodies via compressive techniques often lose much or all of their porosity and gas sorption capacity.

The present inventors have realised that by careful control over particle size distribution during the formation of the COF material, it is possible to form COF materials into high bulk density shapes and forms which are industrially useful and practical without losing sorbent performance, i.e. without losing a significant amount of micro-porosity of the material. In other words, it is possible to form high bulk density yet porous bodies.

Accordingly, in a first aspect, the present invention provides a covalent-organic framework (COF) body comprising a plurality of primary COF particles, some or all of the primary COF particles being agglomerated as COF agglomerates, wherein:
the average diameter of the primary COF particles is between 10 nm and 120 nm;
the average diameter of the agglomerates is larger than the average diameter of the primary COF particles and between 15 nm and 250 nm.

The term ‘agglomerate’ is here used to define a collected group of primary COF particles. The present inventors have found that by controlling the particle size distribution of both primary COF particles and agglomerates to be within the ranges set out here, it is possible to form COF materials into high bulk density shapes and forms which are industrially useful and practical without losing sorbent performance, i.e. without losing a significant amount of micro- or meso-porosity of the material.

The term ‘body’ is here used to define a self-supporting structure. The shape of the body is not particularly limited. A body may alternatively be referred to as a ‘monolith’, ‘pellet’ or ‘bead’. Bodies according to the present invention are preferably not formed by pressing or extrusion processes, contrary to known COF bodies.

In a second aspect, the present invention provides a covalent-organic framework (COF) body consisting of:
a plurality of primary COF particles, some or all of the primary COF particles being agglomerated as COF agglomerates;
optionally, residual solvent,
optionally, residual COF precursors,
optionally, one or more additives, wherein the additives are present at a level of up to 40% by mass;
wherein the average diameter of the primary COF particles is between 10 nm and 120 nm, and the average diameter of the agglomerates is larger than the average diameter of the primary COF particles and between 15 nm and 250 nm.

More preferably, the average diameter of the primary COF particles is between 10 nm and 120 nm, even more preferably between 10 nm and 70 nm, even more preferably between 10 nm and 40 nm. For example, the average diameter of the primary COF particles may be at least 10 nm, at least 20 nm, at least 30 nm, or at least 40 nm. The average diameter of the primary COF particles may be at most 100 nm, at most 90 nm, at most 80 nm, at most 70 nm at most 60 nm or at most 50 nm. In some embodiments the average diameter of the primary COF particles may be about 38 nm.

More preferably, the average diameter of the agglomerates is between 15 nm and 250 nm, more preferably between 50 nm and 200 nm, even more preferably between 80 nm and 150 nm. For example, the average diameter of the agglomerates may be at least 15 nm, at least 50 nm, at least 60 nm, at least 70 nm, at least 80 nm, at least 90 nm, or at least 100 nm. The average diameter of the agglomerates may be at most 250 nm, at most 200 nm, at most 190 nm, at most 180 nm, at most 170 nm, at most 160 nm, at most 150 nm, or at most 100 nm.

Preferably, not more than 10% of the agglomerates forming part of the covalent-organic framework (COF) body have a diameter above a threshold diameter. The threshold diameter may be 800 nm or less. For example, the threshold diameter may be 700 nm, 600 nm or 500 nm. More preferably, not more than 5% of the agglomerates forming part of the covalent-organic framework (COF) body have a diameter above this threshold diameter. More preferably, not more than 1% of the agglomerates forming part of the covalent-organic framework (COF) body have a diameter above this threshold diameter. In some cases, no agglomerate forming part of the covalent-organic framework (COF) body has a diameter greater than the threshold diameter.

The size distribution of the COF particles and agglomerates used to form the COF body can be controlled by suitable process controls to limit the rate of nucleation and rate of reaction. Suitable controls are choice of catalyst, catalyst concentration, monomer (or starting material) concentration, reaction time, reaction temperature, use of additives, and choice of reaction solvent system. Such reaction systems are highly complex and identification of the particle size ranges as key output variables aids in process control. Alternatively, the size distribution of the COF particles and agglomerates may be controlled by suitable mechanical processing or other methods. For example, the inventors contemplate it may be possible to use e.g. ball-milling, or twin-screw extrusion to form a powder pre-mix having an appropriate size distribution from which a COF body can then be manufactured in a suitable manner as discussed below.

The average size of the COF particles and agglomerates forming the body can be determined by any appropriate method. For example, the diameter of the particles and or agglomerates may be determined e.g. by visual examination of scanning electron microscopy (SEM) or transmission electron microscopy (TEM) images. By breaking a body apart to expose internal surfaces and structure, particles and agglomerates forming the body can easily be visualised by an operator. Several surfaces may be examined to minimise any errors arising from localised and unrepresentative defects.

The average diameter of the agglomerates may be calculated by measuring the diameter of 30-50 separate and randomly selected COF agglomerates within a field of view of an SEM or TEM image by visual observation, with the COF agglomerate size being determined as the number average of the measured agglomerate sizes.

The average diameter of the primary COF particles may be determined by measuring the diameter of 2 or 3 primary particles per agglomerate, as above, within a field of view of an SEM or TEM image by visual observation, with the COF primary particle size being determined as the number average of the measured primary particle sizes.

It is also possible to measure primary particle and agglomerate size using atomic force microscopy (AFM), or by non-visual methods. For example, it is also possible to measure primary particle and agglomerate size using small-angle X-ray scattering (SAXS), or small-angle neutron scattering (SANS). Using SAXS, by analysis of data scattered to small angles, characteristics of features such as primary colloidal particles can be measured by fitting various regions of the scattering curves. Using the Guinier equation, the radius of gyration can be calculated giving insights into average particle size, shape and distribution. Porod's law can further be used to obtain the fractal dimension of scattering elements giving an indication of the spatial density of growing primary particles and secondary agglomerates as a function of time and catalyst concentration. See discussion in section G on page 45 of Hench et al. “The sol-gel process”.^{[8]}

If a COF body is formed from particles and agglomerates having average sizes lower than set out above, the COF body may be more difficult to form from the reaction mix and be of lower quality. There are a number of reasons for this. Firstly, primary COF particles having a diameter of less than 10 nm may not be fully formed, or may have a lower proportion of well-formed pores than primary COF particles of a suitable size. For example, for a mesoporous COF material with a pore diameter of 2 nm, a 10 nm primary particle will only extend approximately 5 pore widths across. A significant fraction of the porosity provided by such a primary particle will consist of particle-surface pores, which may be ill-formed or broken open, and as such, may not contribute as effectively to gas storage capacity as well-defined interior particle pores.

Additionally, for some suitable methods of manufacture of COF bodies according to the invention (for example, the method discussed below in relation to the third aspect of the invention), providing COF particles and agglomerates having average sizes lower than set out above may result in pore structure collapse during formation of the COF body, due to large capillary forces generated between particles. COFs are generally mechanically weak materials: the maximum external pressure that a COF material can withstand above which the structure collapses is known as the critical pressure. This can be quantified computationally for any COF material as described in the following reference:

Moghadam P. Z., et al., “Structure-Mechanical Stability Relations of Metal-Organic Frameworks via Machine Learning” Matter 1.1 (2019): 219-234^{[7]}

The inventors have determined that primary COF particle sizes greater than 10 nm and agglomerate sizes greater than 15 nm are preferred to reduce or prevent pore structure collapse during formation of the COF body.

If a COF body is formed from particles and agglomerates having averages sizes higher than set out above, then the resulting structure of the body may not have sufficient mechanical strength and may more easily break into fragments. This can result due to the lower packing density of large agglomerates, resulting in a reduced number of particle:particle contact points. Furthermore, due to the lower packing density, such bodies may have undesirably large macro/mesoporosities. When the particle size ranges are too large, the resulting large interstitial voids that result ensure lower capillary forces, and when coupled with lower particle diffusivity expected from Stokes-Einstein theory, collectively ensure that the system does not reconfigure into a dense monolith upon solvent removal to form the body.

However, a COF body having an appropriate particle/agglomerate size distribution as set out above can have a balance of beneficial properties. Namely, the agglomerates are small enough to have sufficient particle:particle contact points that the COF body has strength and integrity. Furthermore, the agglomerates may pack together in such a way as to provide a degree of interstitial porosity (meso/macroporosity), which can allow for effective ingress and egress of gas to the internal material of the COF body (although such interstitial porosity may not be present in all COF bodies according to the invention—whether such interstitial porosity is desirable will depend on the intended application of the COF body). Accordingly, COF bodies according to the invention may be ‘closed’ bodies (having little or no interstitial porosity), or they may be ‘open’ bodies (having interstitial porosity).

The COF primary particles and/or COF agglomerates may be bonded together by an amorphous COF binder material. The amorphous COF binder material may have the same composition as the COF primary particles and/or COF agglomerates.

The COF body may consist of a mixture of COF and non-COF materials. For example, the COF body may optionally comprise residual solvent. Preferably, if present, the residual solvent is present at a level of not more than 5% by mass, more preferably not more than 3% by mass, more preferably not more than 2% by mass, still more preferably not more than 1% by mass.

The COF body may optionally also comprise one or more additives, wherein the additives are present at a level of not more than 10% by mass. The term ‘additive’ is here used to refer to materials which do not comprise COF precursor materials or their derivatives. Some examples of additives include: metallic species or particles, ions, organic small molecules, or 2D materials such as graphene. However, the additives are not particularly limited, and may consist of a wide range of compounds and materials. In some cases, additives may be present at a level of not more than 5% by mass, more preferably not more than 3% by mass, more preferably not more than 2% by mass, still more preferably not more than 1% by mass. It is permitted for unavoidable impurities to be present in the body.

Alternatively, for other applications it may be advantageous to include a higher proportion of additives in the COF body. For example, where the COF body is used e.g. for catalytic applications, a proportion of the micro- and/or macro-pore space of the body may be filled with one or more additives in order to introduce or protect active sites within the COF body. In such cases the COF body may be referred to as a composite COF body. In these cases, the COF body may optionally also comprise one or more additives, wherein the additives are present at a level of up to 40% by mass, for example up to 10% by mass, up to 20% by mass or up to 30% by mass. The one or more additives may include a binder additive. The binder additive may be a polymeric material. Examples of suitable binder additives include: Ethylene vinyl acetate (EVA), polyethylene (PE), polypropylene (PP), polystyrene (PS), polyethylene glycol (PEG), polymethyl methacrylate (PMMA), polyoxymethylene (POM), polyvinylidene fluoride (PVDF). Where a binder additive is used, it may be present in an amount of e.g. 40 % by mass or less, 30% by mass or less, 20% by mass or less, 10% by mass or less, or 5% by mass or less, as measured relative to the total mass of the COF body. Providing a binder additive present in such amounts may provide for improved physical properties of the COF body as compared with a body which comprises a lower level of binder additive, and improved sorption properties of the COF body as compared with a body which comprising higher levels of binder additive.

However, in some alternative embodiments, the COF body does not comprise a binder additive, or comprises a binder additive only in low levels. Accordingly, the COF body may comprises substantially no binder additive, or may comprises a binder additive as set out above at low levels, for example 1% by mass or less, 0.5% by mass or less or 0.1% by mass or less as measured relative to the total mass of the COF body. In this way the COF body may have improved sorption properties as compared with a body which comprises a higher level of binder additive.

The COF material (comprising agglomerates and/or primary COF particles) forming the body may be formed from a single COF composition.

Alternatively, the COF material forming the body may be formed from two or more different COF compositions. This could be achieved by, for example, forming the body by a method including a step of mixing two or more different reaction mixes, each including different COF particles and/or particle agglomerates, and forming the body from the particles and/or particle agglomerates of the two or more different COF compositions. Such COF bodies may be referred to as multicomponent, composite, blended or mosaic monoliths.

The present invention is considered to have broad applicability to a wide variety of COF materials. Whilst COF materials vary in terms of the nature of their constituent units, the structure and formation of COF bodies from a COF material depends much more on the shape and size of the COF crystallites, rather than the shape of an individual COF unit, framework topology or pore architecture. COF crystallites are typically similar to each other in shape and size since the formation process usually results in reasonably isotropic crystallite shapes. This means that the nature of the close packing of different COF crystallites during COF body formation is similar, independently of the nature of the COF. The COF body may comprise or consist of a 2D COF material. Alternatively, the body may comprise or consist of a 3D COF material.

Particularly suitable COF compositions for use with the present invention include imine and/or hydrazone linked COF compositions. Accordingly, the COF agglomerates and/or primary COF particles forming the body may comprise an imine and/or a hydrazone linked COF composition. The chemistry of hydrazone linked COF compositions is similar to that of imine linked COF compositions. Accordingly, it is expected that these groups of compounds would react in similar ways. In particular, it is expected that similar catalytic techniques applicable to imine-linked COF compositions would also be applicable to hydrazone linked COF compositions.

Examples of imine-linked COFs include 3D-COOH-COF, 3D-COOH-COF, 3D-CuPor-COF, 3D-CuPor-COF-OP, 3D-OH-COF, 3D-Por-COF, 3D-Por-COF-OP, 3D-Py-COF, 3D-Py-COF-2P, 4PE-1P, 4PE-1P-oxi, 4PE-2P, 4PE-3P, 4PE-TT, BF-COF-1, BF-COF-2, BW-COF-AA, BW-COF-AB, CCOF-1, CCOF-2, CC-TAPH-COF, COF-112, COF-300, COF-320, COF-366-Co, COF-366-F4-Co, COF-366-F-Co, COF-366, COF-366-(Ome)2-Co, COF-505, COF-AA-H, COFBTA-PDA, COF-DL229, COF-LZU1, COF-SDU1, COF-TpAzo, CuP-Ph COF, CuP-TFPh COF, DAAQ-TFP COF, DABQ-TFP-COF, DAQ-TFP COF, DaTP, DhaTab, 2,3-DhaTab, 2,5-DhaTab, 2,3-DhaTph, 2,5-DhaTph, 2,3-DhaTta, 2,3-DmaTph, DMTA-TPB1/2′, DMTA-TPB1/3′, DMTA-TPB1/4′, DMTA-TPB1/5′, DMTA-TPB2, DMTA-TPB3, DMTA-TPB4, EB-COF:Br, EB-COF:CI, EB-COF:F, EB-COF:1, FL-COF-1, HAT-COF, HAT-NTBA-COF, HBC-COF, HB-COF-AA, HB-COF-AB, HCC-H2P-COF, HO2C-H2P-COF, SIOC-COF-5, SIOC-COF-6, SIOC-COF-7, TAPB-BMTTPA-COF, TAPB-PDA COF, TAPB-TFP, TAPB-TFPB, Tb-DANT-COF, TBI-COF, TDFP-1, TEMPO-COF, TFB-COF, TfBD, TfpBDH, TH-COF-1, Thio-COF, TPA-COF-1, TPA-COF-2, TpBD, TpBD-2NO2, TP-BDDA-COF, TpBDH, TPBD-ME2, TPB-DMTP-COF, TpBD-NH2, TpBD-NHCOCH3, TpBD-NO2, TpBD-(OMe)2, TpBPy, TP-COF-BZ, TP-COF-DAB, Tp-DANT-COF, TPE-COF-1, TPE-COF-11, TPE-COF-111, TPE-COF-IV, TP-EDDA-COF, TpMA, TpPa-1, TpPa-2, TpPa-F4, TpPa-NO2, TpPa-Py, TpPa-SO3H, TpPa-SO3H-Py, Tp-Stb, TPT-COF-1, TPT-COF-2, TpTD, TpTG-Br, TpTG-C1, TpTG-I, TpPa-1-F2, Tp-Ttba, TRIPTA, TTF-COF, TTF-Py-COF, TTI-COF, TzDa, Tp-Azo, HPB-COF, ILCOF-1-AA, ILCOF-1-AB, iPrTAPB-TFP, iPrTAPB-TFPB, LZU-301, LZU-301-sol, LZU-70, LZU-72, LZU-76, N3-COF, NN-TAPH-COF, NS-COF, NUS-10, NUS-14, NUS-15, NUS-9, HO-H2P-COF, OH-TAPH-COF, PC-COF, PI-2-COF, PI-3-COF, Por-COF, Py-1 P COF, Py-1 PF COF, Py-2,2′-BPyPh-COF, Py-2,3-BPyPh-COF, Py-2,3-DHPh-COF, Py-2PE COF, Py-3PEBTD COF, Py-3PE COF, Py-An COF, Py-DHPh COF, PyTTA-BFB1m-iCOF, RT-COF-1, SA-COF, Salen-COF, SB-PORPy, SIOC-COF-3-AB, and SIOC-COF-4-AB.

Examples of hydrazone-linked COFs include COF-42-bnn, COF-42-gra, COF-43-bnn, COF-43-gra, COF-ASB, COF-LZU8, CPF-1, CPF-2, and TFPT-COF.

The bulk density of the COF body may be at least 80% of the calculated density of a COF single crystal of the same composition as the body. Preferably the bulk density of the COF body may be at least 85%, at least 90%, at least 95%, at least 100%, at least 105%, at least 120%, or at least 140% of the calculated density of a COF single crystal of the same composition as the body. The density of the COF single crystal of the same composition can be determined by calculation based on knowledge of the crystal structure.

The bulk density of the COF body may be between about 700 and 1200 g/l. However, the precise bulk density is not particularly limited, and will depend on the identity of the COF material from which the body is formed. For example, some COF single crystal densities may be as low as e.g. 0.1 g/ml (100 g/l). In this case, a COF body comprising particles and/or agglomerates formed from this COF composition may have a bulk density in the region of 80-120 g/l.

The covalent-organic framework (COF) body may have a BET area at least 600 m²/g, preferably at least 1000 m²/g, wherein the BET area is determined based on the N₂ adsorption isotherm at 77K. Having a BET area in this range may indicate good performance of the COF body for particular applications (in particular for N₂ storage). However, a low BET area is not necessarily an indicator of poor performance in other applications. For example, some materials with low BET areas (e.g. <30 m²/g), determined based on the N₂ adsorption isotherm at 77K, may have excellent uptake of smaller gas molecules, for example CO₂. Such materials may also have excellent gas separation performance. Accordingly, in some cases, the covalent-organic framework (COF) body may have a BET area determined based on the N₂ adsorption isotherm at 77K of less than 600 m²/g.

The covalent-organic framework (COF) body may have a volume of at least 0.5 mm³. For example, the volume of the monolith may be at least 1 mm³, more preferably at least 2 mm³, more preferably at least 3 mm³. In some cases, the covalent-organic framework (COF) body may have a volume of at least 4 mm³, at least 5 mm³, at least 10 mm³ or more, or 100 mm³ or more. It is contemplated that a body having a volume in the range 1 mm³ to 10 mm³ may be most convenient for industrial applications, although this may depend on the specific industrial application. It is possible to measure the bulk volume of a monolith by the Archimedes method in a mercury porosimeter, i.e. by determining the volume of mercury displaced by the monolith before allowing the mercury to infiltrate the pores of the monolith.

Preferably, the COF body has a smallest linear dimension of at least 0.5 mm, or at least 1 mm. That is, assuming that the body is not perfectly spherical, the shortest straight line passing through the material of the body has a length in the body of at least 0.5 mm, or at least 1 mm. This dimension may be considered to be the thickness of the body, depending on the overall shape of the body. More preferably, the COF body has a smallest linear dimension of at least 5 mm.

In a third aspect, the present invention provides a method for manufacturing a covalent-organic framework (COF) body, comprising the steps of:
providing a COF material comprising primary COF particles and agglomerates of primary COF particles, the primary COF particles having an average diameter of between 10 nm and 120 nm, the agglomerates having an average diameter of between 15 nm and 250 nm;
centrifuging a liquid suspension comprising the COF material and one or more selected solvents to form a COF concentrate; and
performing a temperature-controlled drying step to remove at least some of the solvent from the COF concentrate to thereby form the COF body.

Preferably, the step of providing a COF material comprising primary COF particles and agglomerates of primary COF particles includes allowing the reaction of COF precursors in a reaction mix including one or more selected solvents to thereby form the particles and/or particle agglomerates of the COF material. Where this is the case, the liquid suspension comprising the COF material and one or more selected solvents which is subsequently centrifuged may be the reaction mix after reaction of the COF precursors.

Alternatively, a COF material having an appropriate size distribution or primary particles and agglomerates may be provided using a suitable mechanical processing methods. For example, the COF material may be provided by using e.g. a ball-milling or twin-screw extrusion process to form a powder pre-mix having an appropriate size distribution from which a COF body can then be manufactured. A liquid suspension of the COF material may then be formed by adding one or more liquids including one or more suitable solvents to the powder pre-mix.

Where the step of providing a COF material comprising primary COF particles and agglomerates of primary COF particles includes allowing the reaction of COF precursors in a reaction mix including one or more selected solvents to thereby form the particles and/or particle agglomerates of the COF material, preferably the reaction mix further comprises one or more catalysts.

The one or more catalysts may comprise an acid catalyst. For example, the one or more catalysts may be selected from one or more of: a metal triflate (including scandium triflate, indium triflate, ytterbium triflate, yttrium triflate, europium triflate, zinc triflate and lanthanide triflates); p-toluenesulfonic acid; acetic acid; benzoic acid; p-nitrobenzenesulfonic acid; benzenesulfonic acid; p-phenolsulfonic acid; trifluoroacetic acid; hydrochloroic acid; and/or sulphuric acid. However, other catalysts may be selected as appropriate depending on the choice of COF precursors and/or solvents in the reaction mix.

The one or more catalyst may be provided in an amount suitable for catalysing a reaction of COF precursors to form the COF material. The precise amount of catalyst will depend on the starting materials (COF precursor materials), the solvent(s) and the temperature of the reaction mix. For an imine-linked COF material, scandium triflate may be used as a catalyst in concentrations of e.g. 4 g/l or less.

Where the step of providing a COF material comprising primary COF particles and agglomerates of primary COF particles includes allowing the reaction of COF precursors in a reaction mix including one or more selected solvents to thereby form the particles and/or particle agglomerates of the COF material, the reaction time may be selected as appropriate based on the identity of the COF precursors, the identity of the one or more solvents, and the optional presence of one or more catalysts. In some cases, the reaction time may be 72 hours or less, preferably 12 hours or less, more preferably 6 hours or less, more preferably 1 hour or less. For example, the reaction time may be about 15 minutes, about 30 minutes or about 60 minutes. The reaction of COF precursors to thereby form the particles and/or particle agglomerates of the COF material may take place at temperatures greater than 20° C., greater than 50° C., or greater than 100° C. Preferably, the reaction temperature is in a range from about 20° C. to about 60° C. For example, the reaction temperature may be about 20° C., about 30° C., about 40° C., about 50° C., or about 60° C.

The one or more solvents may be selected from one or more of e.g. mesitylene, 1,4-dioxane, acetonitrile, methanol, ethanol, isopropanol, n-butanol, 1,2-dichlorobenzene, 1-chlorobenzene, water, acetone, N,N-dimethylformamide, N-methyl-2-pyrrolidone, aniline, m-cresol, dimethylsulfoxide, tetrahydrofuran, toluene, chloroform, dichoromethane, xylene, tetrachloroethane, and/or trichloroethane. However, other solvents may be selected as appropriate depending on the choice of COF precursors in the reaction mix. A single solvent may be used, or a combination of two or more different solvents may be used. A particularly preferred solvent system is acetonitrile (CH₃CN or MeCN) in combination with a 1:1 (v/v) mixture of mesitylene and dioxane, in particular for production of TPB-DMTP-COF COF bodies. Another particular preferred solvent system is acetone in combination with 1,4-dioxane, in particular for production of 3D COF bodies such as COF-300-OMe (a methoxylated variant of COF-300).

Where the solvent system is acetonitrile (commonly abbreviated as CH₃CN or MeCN) in combination with a 1:1 (v/v) mixture of mesitylene and dioxane, the acetonitrile solvent volume fraction may be in a range of about 0.55 to about 0.85, the remainder being 1:1 (v/v) mixture of mesitylene and dioxane. More preferably, the acetonitrile solvent volume fraction may be in a range of 0.6-0.85, more preferably about 0.67-0.78, most preferably about 0.75. When the acetonitrile is present in a volume fraction of greater than about 0.85, the resultant particle size distribution may be such that a ‘closed’ body may be formed, i.e. a body having low levels of interstitial porosity, which may reduce or prevent effective ingress and/or egress of gases or small molecules. When the acetonitrile is present in a volume fraction of less than about 0.55, the resultant particle size distribution may be such that a powder may be formed rather than a body.

Where the solvent system is acetone in combination with 1,4-dioxane, the acetone solvent volume fraction may be in a range of about 0.55 to about 0.95 (v/v), preferably about 0.6 to about 0.85, for example about 0.83 (v/v). Providing such a solvent system can result in COF bodies having satisfactory properties.

The density of the one or more solvents may be selected to be less than the calculated density of a single crystal of the COF material (the target COF composition). In this way, during the step of centrifuging the liquid suspension comprising the COF material and one or more selected solvents to form a COF concentrate, the COF particles and agglomerates will be driven to the bottom of the container during centrifuging and may more effectively compact against a wall of the container. Alternatively, the density of the one or more solvents may be selected to be greater than the calculated density of a single crystal of the COF material. In this way, the COF particles and agglomerates would rise to the surface of the liquid suspension during centrifuging, whereby they could be removed from the liquid suspension by skimming.

Preferably the absolute density difference between the one or more solvents and the calculated density of a single crystal of the COF material is >0.2 g/l. In this way it may be easier to form a COF concentrate during centrifugation. If the density of the COF material and the liquids in the liquid suspension are identical, it will not be possible to effectively concentrate the COF material by centrifugation.

The step of centrifuging the liquid suspension comprising the COF material and one or more selected solvents to form a COF concentrate may be performed with a force of up to 100000 g. Preferably the centrifugation is performed with a force of between 500 and 10000 g, more preferably between 750 g and 6000 g, and even more preferably between 1000 g and 4000 g. If the applied g force is not high enough then concentration of the COF particles and agglomerates to a COF concentrate can take excessively long times. If the g force is too high, then COF particles and agglomerates and/or processing equipment may easily suffer damage.

The temperature-controlled drying step may be performed with a maximum temperature of not more than 60° C. In some embodiments the maximum temperature of the temperature-controlled drying step may be not more than 50° C., not more than 40° C., or not more than 30° C. The precise temperature may be selected with consideration of the identity of the solvent(s) to be removed from the COF concentrate. For example, the temperature of the temperature-controlled drying step may be selected based on a known vaporisation temperature of the solvent(s) to be removed from the COF concentrate.

The temperature-controlled drying step may be performed for a time of between 12 and 72 hours, preferably for a time of at least 24 hours, although in some cases the temperature-controlled drying step may be performed for a time of at least 48 hours.

In some cases, the temperature-controlled drying step may be performed under ambient conditions. In other cases, the temperature-controlled drying step may be performed in an inert environment. For example, the temperature-controlled drying step may be performed in a nitrogen or argon atmosphere.

The method may include a step of activating the COF material. Activation involves the expulsion of undesired substances that remain in the pore structure of the COF material immediately following synthesis (e.g. impurities, remaining COF precursor materials, trapped solvent molecules etc.). Through this expulsion or “activation”, the sorption capacity of the COF material can be improved. The step of activating the COF material may include washing the COF material in a suitable solvent. For example, the COF material may be washed in methanol. The washing may be performed for a length of time of 12 hours or more, preferably 24 hours or more, more preferably 48 hours or more. A longer wash time may provide for improved BET surface area of the COF composition by ensuring more complete activation. The temperature may be controlled during the washing step. For example, the temperature of the solvent may be controlled to be in a range of e.g. about 20° C. to about 120° C. during the washing step. Preferably the step of activating the COF material (for example by washing the COF material in a suitable solvent) occurs after the step of centrifuging a liquid suspension comprising the COF material and one or more selected solvents to form a COF concentrate. Preferably the step of activating the COF composition (for example by washing the COF material in a suitable solvent) occurs before the step of performing a temperature-controlled drying step to remove at least some of the solvent from the COF concentrate to thereby form the COF body.

In some methods, the COF material may be activated by washing the COF material in supercritical carbon dioxide, supercritical carbon dioxide (sCO₂) being a fluid state of carbon dioxide (CO₂), where it is held at or above its critical temperature and critical pressure. As capillary forces are known to be proportional to the surface tension of the in-pore fluid, the use of supercritical carbon dioxide as an ultra-low surface tension solvent can provide improved washing by reduction of mechanical damage to individual crystallites (primary particles) during the washing process. COF materials washed using supercritical carbon dioxide may therefore display improved BET area. For example, the BET area may be increased to over 2,500 m² g⁻¹. Where the COF material is washed using supercritical carbon dioxide, the temperature-controlled drying step may be performed at a (pressure release) rate of from about 0.1 bar/h to about 20 bar/h, more preferably from about 0.1 bar/h to about 8 bar/h, even more preferably from about 0.1 bar/h to about 3 bar/h.

In a fourth aspect, the present invention provides a covalent-organic framework (COF) body produced according to the method of the third aspect. The COF body is preferably a COF body as defined in relation to the first or second aspects of the invention.

In a fifth aspect, the present invention provides a population of COF bodies consisting of a plurality of COF bodies according to the first, second or fourth aspects of the invention. Such a population is of use in various applications, for example for use in gas storage applications, or gas separation applications.

The plurality of COF bodies may be of substantially similar shape and/or dimension. They may be used in a column arrangement with the spaces between them allowing for fluid (e.g. gas) flow. The number of bodies in the population is not particularly limited, but as an example the number of bodies may be at least 10, or at least 50, or at least 100.

In a sixth aspect, the present invention provides a gas storage system comprising a gas storage vessel and a population of COF bodies according to the fifth aspect, wherein the population of COF bodies is disposed within the gas storage vessel.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows the structure of one TPB-DMTP-COF, a COF material suitable for use in the present invention.

FIG. 2 shows (a) an overlaid graph of PXRD data for COF powders produced using pure component solvents; and (b) an overlaid graph of PXRD data for COF powders produced using mixed component solvents.

FIG. 3 shows SEM images of TPB-DMTP-COF synthesized in (a) chloroform, (b) dichloromethane, (c) methanol, (d) a 1:1 (v/v) mixture of 1,3,5-trimethylbenzene and 1,4-dioxane, (e) a 1:1 (v/v) mixture of n-butanol and o-dichlorobenzene, and (f) a 1:1 (v/v) mixture of methanol and 1-chlorobenzene.

FIG. 4 shows a PXRD pattern of a COF body produced according to the invention, indicating major crystallographic peaks observed.

FIG. 5 shows various SEM images (a)-(d) of a COF body produced according to the invention taken at different magnifications.

FIG. 6 is a TEM image taken of a COF body produced according to the invention, including a graph indicating the size distribution of primary COF particles (inset).

FIG. 7 shows an overlaid graph comparing PXRD patterns for bodies produced according to the present invention. The patterns indicate no major differences in crystallinity when the reaction is scaled up by a factor of four.

FIGS. 8(a), (b) show SEM images of a COF body produced according to the invention at different magnifications after the reaction is scaled up by a factor of four.

FIG. 9 shows SEM images of various COF samples, showing solid state packing of TPB-DMTP-COF as a function of synthesis solvent.

FIG. 10 shows (a) BET area as a function of synthesis solvent; (b) intensity of the (100) crystallographic peak taken from the respective PXRD patterns as a function of synthesis solvent; (c) nonlocal density functional theory (NLDFT) pore size distribution of powders and open monoliths.

FIG. 11 shows overlaid isotherms of TPB-DMTP-COF bodies activated under different washing procedures.

FIG. 12 shows overlaid nonlocal density functional theory (NLDFT) pore size distributions of the same TPB-DMTP-COF bodies as FIG. 11.

FIG. 13 shows BET area as a function of synthesis solvent for scaled up and activated TPB-DMTP-COF bodies.

FIG. 14 shows (a) a plot comparing the experimental nitrogen isotherm measured at 77 K for a methanol activated 0.75 acetonitrile system, a supercritical carbon dioxide activated 1.00 acetonitrile system and a theoretical nitrogen isotherm derived from GCMC simulations performed on the theoretical structure exhibiting AA interlayer stacking; (b) a semi-logarithmic plot comparing the same data as in (a).

FIG. 15 shows theoretical isotherms in various units for commercial gases derived from GCMC simulations.

FIG. 16 shows BET area as a function of (a) catalyst concentration; (b) amine concentration; (c) time.

FIG. 17 shows overlaid graph comparing PXRD patterns of COF-300-OMe synthesized using different catalyst concentrations.

FIG. 18 shows an SEM image of COF-300-OMe synthesized in 1,4-dioxane using a catalyst concentration of 0.50 g L⁻¹.

FIG. 19 shows an SEM image of COF-300-OMe synthesized in a 0.83 volume fraction 1,4-dioxane in acetone solvent system using a catalyst concentration of 0.50 g L⁻¹.

FIG. 20 shows an SEM image of COF-300-OMe synthesized in a 0.83 volume fraction 1,4-dioxane in acetone solvent system using a catalyst concentration of 0.75 g L⁻¹.

FIG. 21 shows an SEM image of COF-300-OMe synthesized in a 0.83 volume fraction 1,4-dioxane in acetone solvent system using a catalyst concentration of 0.63 g L⁻¹.

FIG. 22 shows an SEM image of COF-300-OMe synthesized in a 0.83 volume fraction 1,4-dioxane in acetone solvent system using a catalyst concentration of 0.50 g L⁻¹, with an extended reaction time of 60 minutes.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

In particular, in the current work, the solution-phase shaping and densification of COFs into centimetre scale monolithic pellets (bodies) is demonstrated. Pellets thus formed are mechanically robust and exhibit high internal surface areas (e.g. around 900 m²g⁻¹ or greater, up to around 1300 m² g⁻¹ or in some instances 2500 m² g⁻¹). It is shown that the solid-state packing of these bodies can be controlled e.g. by choice of synthesis solvent to control COF primary particle and agglomerate size to thereby produce hierarchically porous structures enabling fast diffusion of gases into and out of COF pore spaces. Grand canonical Monte Carlo (GCMC) simulations indicate that these materials may be capable of delivering among the highest adsorption capacities for carbon dioxide capture in the presence of humidity.

In selecting an initial system capable of affording high degrees of crystallinity and control over particle size, Lewis Acid catalytic methods were adapted and employed. See, work by Matsumoto, M., et al.^{[2]}.

These systems make use of efficient and water-tolerant metal triflate catalysts to prepare COF powders within minutes at room temperature with crystallinities, in some cases, approaching that of the theoretical maximum. As these methods are broadly applicable to the synthesis of imine-linked COFs, findings made in the present work can be subsequently generalized to other such COFs in the exploration of materials for a desired application. With its superior crystallinity, chemical stability, and amenability to pre- and post-polymerization modifications, TPB-DMTP-COF was selected as a trial system from which colloidal processing and monolith formation could be explored. While this material bears close structural similarity to TAPB-PDA-COF, from which colloidal particles 200-600 nm in diameter had been previously demonstrated, no prior synthetic procedure using Lewis Acid catalytic methods had been reported, necessitating a broad screen of synthetic conditions.

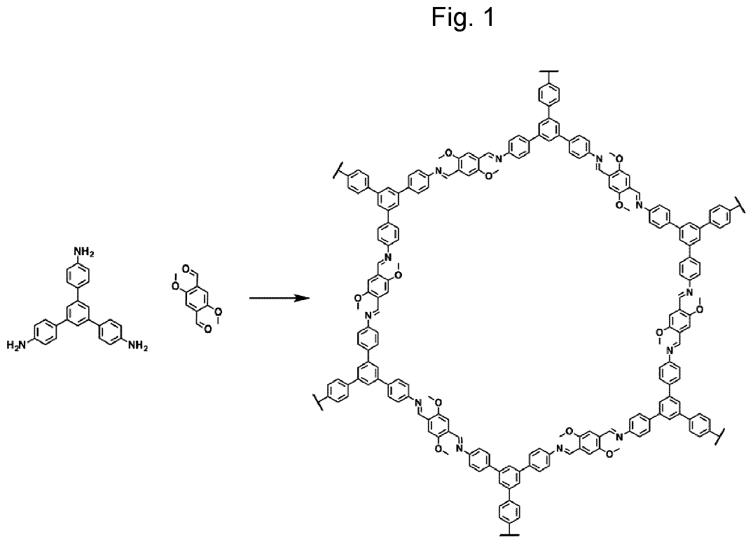

FIG. 1 shows the structure of TPB-DMTP-COF (indicating monomers and pore structure).

Investigation of Suitable Solvents for Production of a TPB-DMTP-COF COF Body

Using stoichiometric quantities of amine (1,3,5-tris(4-aminophenyl)benzene) and aldehyde (2,5-dimethoxybenzene-1,4-dicarboxaldehyde) and a catalyst at a given concentration, six single component and six multicomponent solvent systems were prepared as follows and then characterised:

To a 15 mL centrifuge tube were added 1,3,5-tris(4-aminophenyl)benzene (35.15 mg, 100 μmol) and 2,5-dimethoxybenzene-1,4-dicarboxaldehyde (29.13 mg, 150 μmol). Solvent (4 mL) was then added and the mixture was sonicated briefly to a homogenous suspension. Scandium(III)trifluoromethanesulfonate (3 mg, 6 μmol) was added, the tube was sealed, and the mixture was sonicated again for ca. 20 seconds. The mixture was then left to react for 30 minutes undisturbed. The sample powder was collected by centrifugation, washed with three portions of solvent (12 mL each) and an additional portion of methanol (12 mL), and was solvent exchanged in methanol (12 mL) for 24 hours. The powder was dried overnight at 120° C. under vacuum.

These solvent systems included one that had been reported for the synthesis of TPB-DMTP-COF under solvothermal conditions, a 1:1 (v/v) mixture of n-butanol and o-dichlorobenzene^{[1]}, and one that had been reported for the synthesis of TAPB-PDA-COF under Lewis Acid catalyzed conditions, a 1:4 (v/v) mixture of 1,3,5-trimethylbenzene and 1,4-dioxane^{[2]}. While low dielectric constant solvents have been shown to be preferred for imine exchange reactions^{[3]}, some moderate to high dielectric constant solvents were also included.

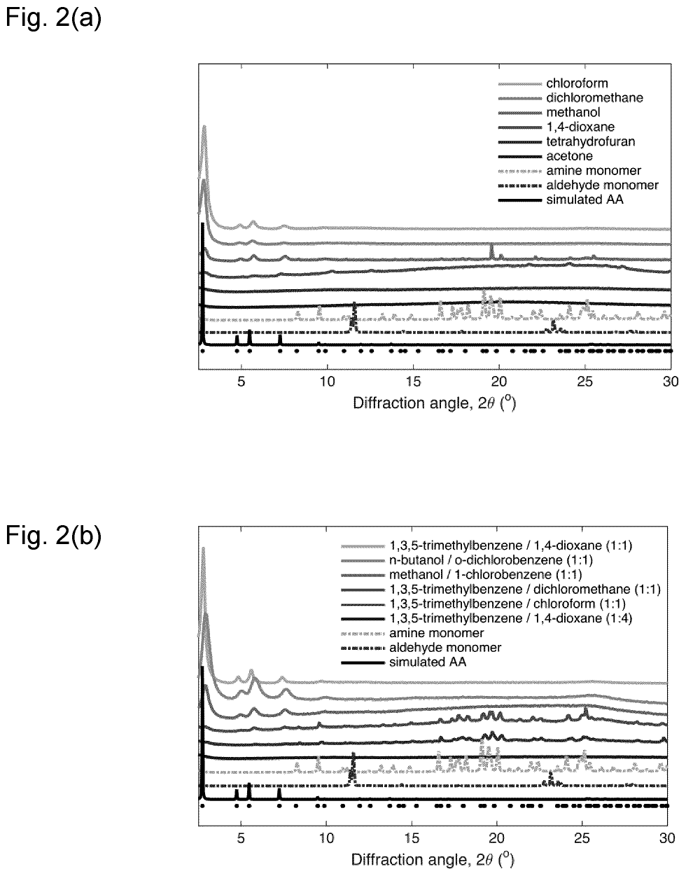

Powder X-ray diffraction on finished COF powders gave crystalline patterns for several solvent systems as indicated in FIG. 2, which shows (a) an overlaid graph of PXRD data for COF powders produced using pure component solvents; and (b) an overlaid graph of PXRD data for COF powders produced using mixed component solvents. Among the single component solvents, chloroform and dichloromethane performed the best, with the 1:1 (v/v) mixture of 1,3,5-trimethylbenzene (also known as mesitylene) and 1,4-dioxane giving best results among multicomponent systems.

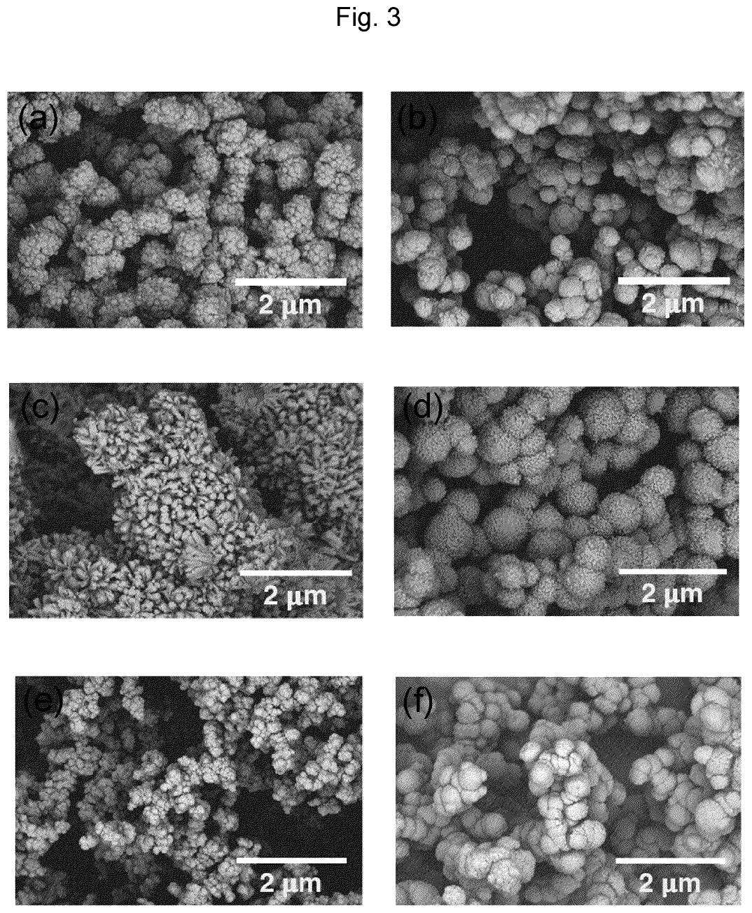

SEM imaging of samples (see FIG. 3, (a)-(f)) exhibiting the best crystallinity revealed strikingly different morphological outcomes. FIG. 3(a) is an SEM image of TPB-DMTP-COF synthesized in chloroform, FIG. 3(b) is an SEM image of TPB-DMTP-COF synthesized in dichloromethane, FIG. 3(c) is an SEM image of TPB-DMTP-COF synthesized in methanol, FIG. 3(d) is an SEM image of TPB-DMTP-COF synthesized in a 1:1 (v/v) mixture of 1,3,5-trimethylbenzene and 1,4-dioxane, FIG. 3(e) is an SEM image of TPB-DMTP-COF synthesized in a 1:1 (v/v) mixture of n-butanol and o-dichlorobenzene, and FIG. 3(f) is an SEM image of TPB-DMTP-COF synthesized in a 1:1 (v/v) mixture of methanol and 1-chlorobenzene.

In all cases, there was evidence to suggest that the powder microstructure exists as agglomerations of discrete, primary particles less than 100 nm in diameter that subsequently aggregate into larger secondary structures with diameters greater than 100 nm.

One Example of Production of Monolithic COFs

Further experiments were then performed using acetonitrile as a solvent^{[2]}, using the protocol as follows:

To a 15 mL centrifuge tube were added 1,3,5-tris(4-aminophenyl)benzene (35.15 mg, 100 μmol) and 2,5-dimethoxybenzene-1,4-dicarboxaldehyde (7.30 mg, 38 μmol). Solvent (4 mL) was then added and the mixture was sonicated briefly to a homogenous suspension. Scandium(III)trifluoromethanesulfonate (3 mg, 6 μmol) was added, the tube was sealed, and the mixture was sonicated again for ca. 20 seconds. The mixture was then left to react for 30 minutes undisturbed. The sample powder was collected by centrifugation, washed with three portions of solvent (12 mL each) and an additional portion of methanol (12 mL), and was solvent exchanged in methanol (12 mL) for 24 hours. The solvent was then decanted, washed with methanol (12 mL), and left to dry at 20° C. for a further 24 hours. The body was dried overnight at 120° C. under vacuum prior to characterization.

A glassy pellet resulted that exhibited remarkable mechanical strength.

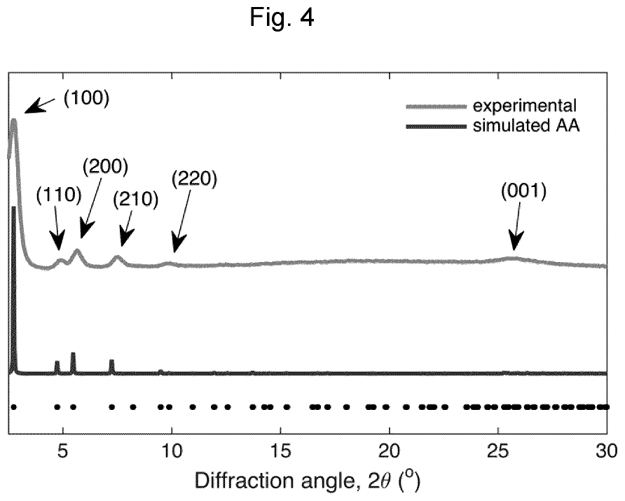

FIG. 4 shows a PXRD pattern of the resultant COF body, indicating major crystallographic peaks observed.

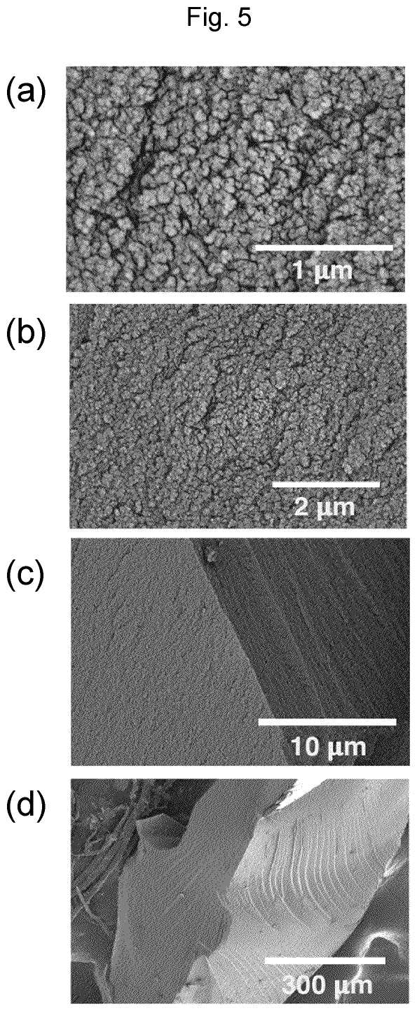

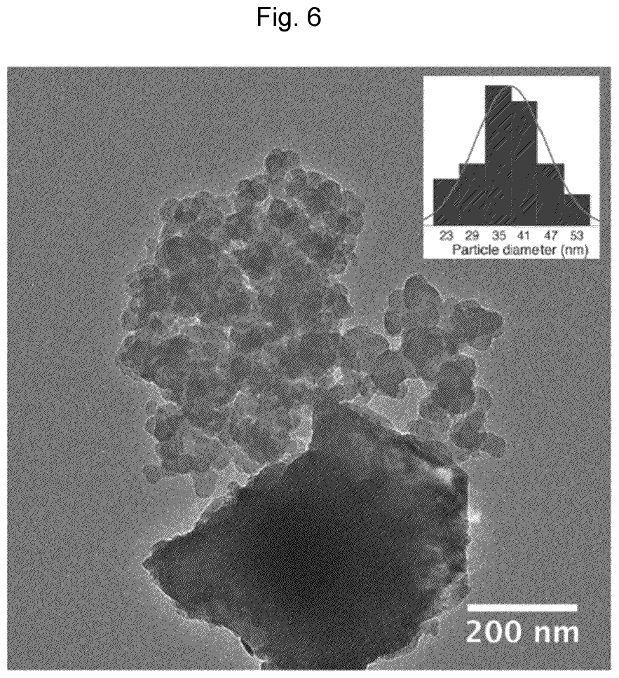

Analysis of the ground pellet by SEM (see FIG. 5(a), (b), (c), (d)) revealed that particles exist as macroscopic glassy shards exhibiting smooth surfaces and showing evidence of clean conchoidal fracturing—a common characteristic of brittle materials (e.g. silica and flint) exhibiting no natural planes of separation. At higher magnifications, surfaces appeared as rough aggregations of much smaller, discrete particles. Further analysis by TEM (see FIG. 6) confirmed the presence of a nanostructure comprised of assemblies of primary COF particles 38±8 nm (n=30, n being the number of particles used in the calculation, i.e. the sample size) in diameter packed closely together to form agglomerates with little to no interstitial space. Collectively, these results confirmed the formation of crystalline monoliths.

These materials were successfully scaled up by a factor of four without major differences either in crystallinity or morphology using the following protocol:

To a 50 mL centrifuge tube were added 1,3,5-tris(4-aminophenyl)benzene (140.60 mg, 400 μmol) and 2,5-dimethoxybenzene-1,4-dicarboxaldehyde (29.13 mg, 150 μmol). Solvent (16 mL) was then added and the mixture was sonicated briefly to a homogenous suspension. Scandium(III)trifluoromethanesulfonate (12 mg, 24 μmol) was added, the tube was sealed, and the mixture was sonicated again for ca. 20 seconds. The mixture was then left to react for 30 minutes undisturbed. The sample powder was collected by centrifugation, washed with three portions of solvent (40 mL each) and an additional portion of methanol (40 mL), and was solvent exchanged in methanol (40 mL) for 24 hours. The solvent was then decanted, washed with methanol (40 mL), and left to dry at 20° C. for a further 24 hours. The body was dried overnight at 120° C. under vacuum prior to characterization.

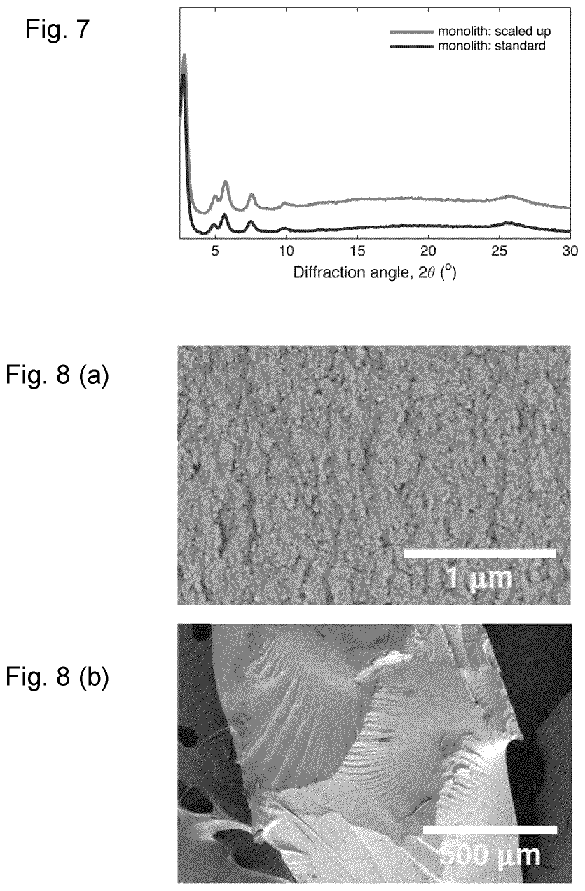

The resulting characterisation of scaled up bodies is shown in FIG. 7 (showing an overlaid graph comparing PXRD patterns for initially produced and standard protocol bodies as compared with scaled up bodies). It can be seen that there is substantially no difference in the major crystallographic peaks identified, showing that there is no major difference in either crystallinity or morphology between bodies produced according to the ‘standard’ and ‘scaled up’ protocols. FIGS. 8(a) and (b) shows SEM images of a COF body produced according to this ‘scaled’ protocol at different magnifications.

Production of Further Monolithic COFs from TPB-DMTP-COF

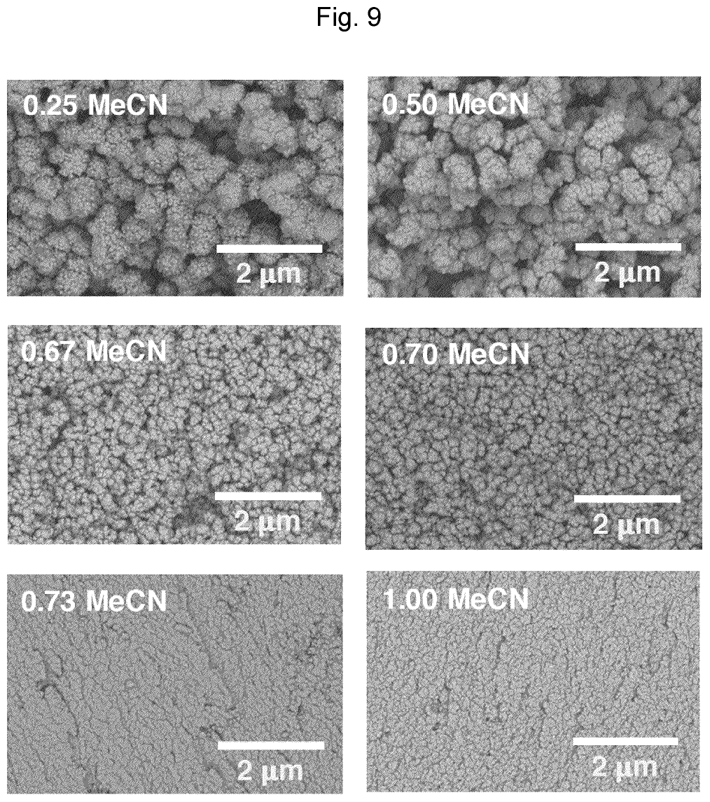

Taking acetonitrile and the 1:1 (v/v) mixture of mesitylene and dioxane as extremes from which phase pure monoliths and powders could be respectively obtained in high crystallinity, solvent systems were prepared and the resulting COF materials analysed. The resulting systems produced monoliths in typical yields above 90% that upon characterization exhibited three distinct solid state packings characteristic of powders, permeable “open” monoliths and impermeable “closed” monoliths. FIG. 9 shows SEM images of various COF samples, showing solid state packing of TPB-DMTP-COF as a function of synthesis solvent—the amount of acetonitrile (MeCN) is indicated. The remaining proportion is 1:1 (v/v) mixture of mesitylene and dioxane. For example, for the samples indicated as 0.50 MeCN, the remaining solvent fraction is 0.50 1:1 (v/v) mixture of mesitylene and dioxane.

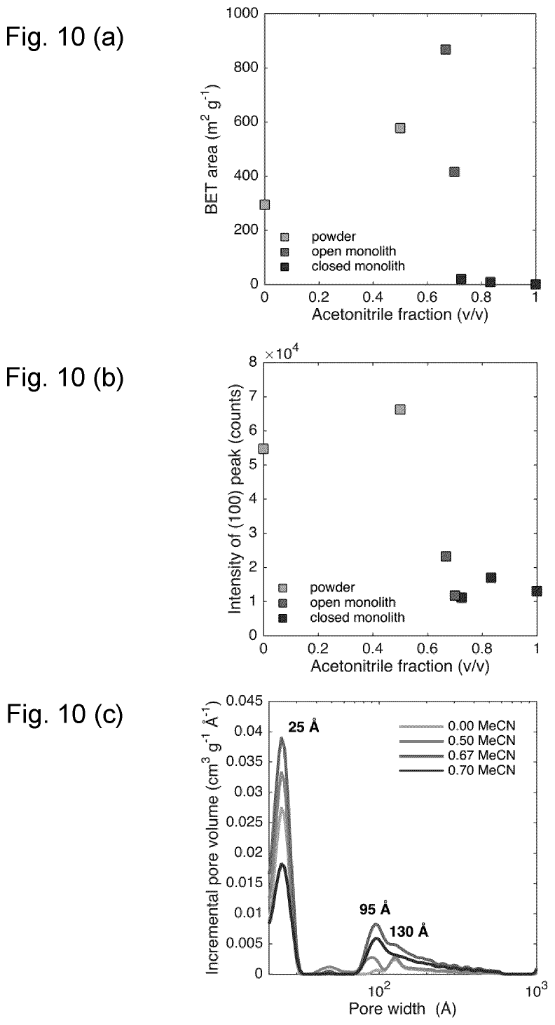

It can be seen that increasing the acetonitrile volume fraction increases the solid state packing density due to the reduction in agglomerate size, thereby leading to monolith formation. At acetonitrile fractions below 0.67 powdered systems were solely obtained. Crystallinity for these systems is almost completely preserved showing little evidence of anisotropic ordering and manifesting high nitrogen capacities. At acetonitrile fractions between 0.67 and 0.70, bodies were produced which exhibited Type IVc isotherms with BET areas just below 900 m²g⁻¹—similar to those of powder systems (FIG. 10a). The nanostructure of these materials is characterized by a polydispersity of agglomerate sizes with an average diameter of approximately 150 nm. Primary COF particles forming these agglomerates have a size range of about 30 nm to 50 nm. The lower interstitial space, while not enough to result in loss of gas permeability, does reduce the intensity of the (100) peak to levels consistent with those of closed monoliths (FIG. 10b) suggesting that some mechanical disruption of crystallites may take place.

Analysis of the non-local density functional theory (NLDFT) pore size distributions (FIG. 10c) confirms that while crystalline COF pores (25 Å) are the dominant free volume elements, substantial mesoscale elements with average diameters of about 95 Å and about 130 Å in width exist that vary in relative prominence favouring the smaller value as the system becomes more monolithic.

Above acetonitrile fractions of 0.70, closed monoliths are obtained. The crystallinity for these remains comparable to that of open monoliths but nitrogen uptake drops off dramatically suggesting that the hierarchical porosity (or the interparticle mesopores) present in the open systems may play a role in permitting ingress and egress of gas within the monolithic body.

To assess the extent to which incomplete activation contributes to the low N₂ uptake observed for various monolithic bodies, three additional 0.67 acetonitrile samples were prepared and washed using different methods. Activation, as described previously, involves the expulsion of undesired substances that remain in the pore structure immediately following synthesis (e.g. impurities, remaining COF precursor materials, trapped solvent molecules etc.). Through this expulsion or “activation”, the sorption capacity of the porous material can be improved.

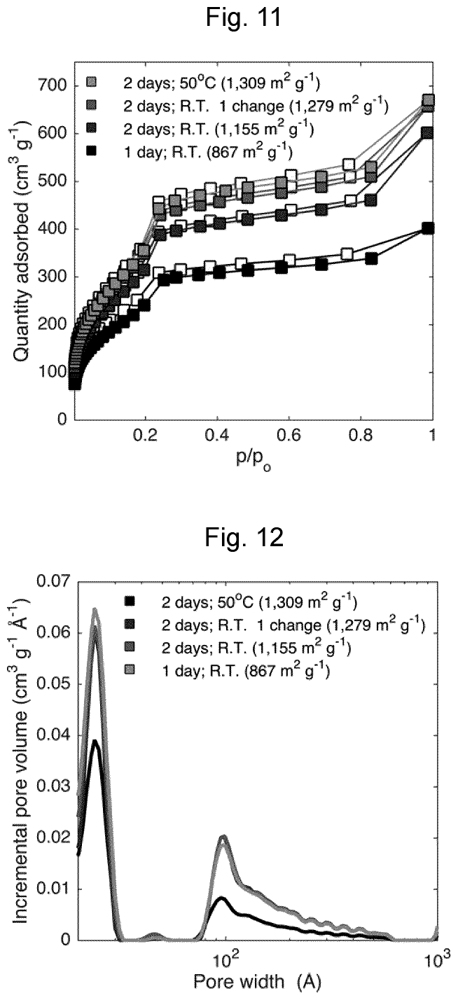

Extending the wash time in methanol from the standard 1 day to 2 days gives a dramatic improvement in BET area from 867 m² g⁻¹ to 1,155 m² g⁻¹, as shown in FIG. 11, which displays overlaid isotherms of the TPB-DMTP-COF bodies produced from an 0.67 acetonitrile system. The solvent at the end of this period is pale brown, compared to the more characteristic clear solution obtained after one day, indicative of additional dissolved components. Exchanging the solvent after 24 hours yielded further enhancements in nitrogen uptake, with no visible discoloration of the exchanged solvent at the end of the 2-day period. Compared with methods of MOF washing and activation, which have been shown to be complete after a few minutes^{[6]} these results indicate that the corresponding timescales for COF monoliths are substantially longer—consistent with existing literature procedures (e.g. Soxhlet extraction) for COF powder activation^{[1]}. Best results were obtained after heating the sample to 50° C. during washing in methanol. BET areas up to 1,309 m² g⁻¹ were achieved with pronounced discoloration of the wash solvent suggesting that removal of unreacted components and low molecular weight phases is most complete under these conditions.

Analysis of the respective NLDFT pore size distributions (see FIG. 12 which shows overlaid NLDFT pore size distributions of the same TPB-DMTP-COF bodies as analysed in FIG. 10c) showed no detectable changes in the pore profiles across the various methods of activation employed.

Collectively, these results confirm that improvements in monolith performance can be obtained without any disruption to the hierarchical pore structure previously established by use of more rigorous washing and activation protocols. They also suggest that the lack of N₂ uptake previously observed for closed monoliths was in part due to the presence of substantial quantities of impurities or otherwise pore-blocking substances.

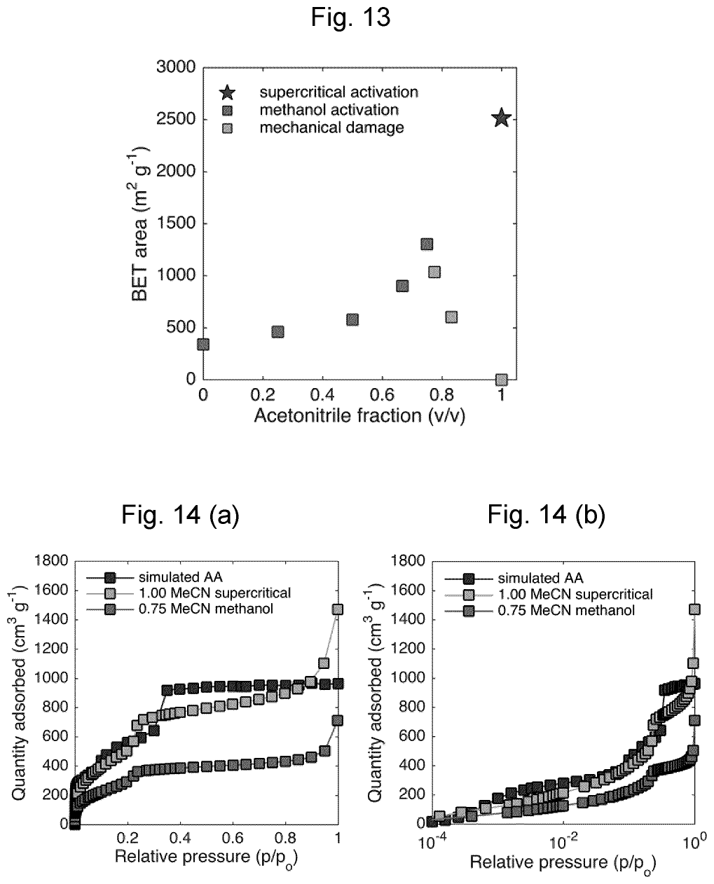

To determine the effect of improved activation on the BET area of COF monoliths over the range of reaction solvent systems examined, the reaction was scaled up by a factor of four and was subjected to an activation procedure consisting of heating the sample to 50° C. during washing in methanol. After 24 hours, the methanol was additionally exchanged to ensure complete activation was achieved under the scaled up conditions. FIG. 13 shows BET area as a function of synthesis solvent for the set of scaled up COF body samples on which this improved activation procedure has been performed. The new series shows the characteristic maximum behaviour as was previously established. However, the increase in scale does result in a shift in the position of the maximum in BET area to an acetonitrile fraction of around 0.75. In both instances, the maximum BET area obtained with improved activation methods is around 1,300 m² g⁻¹. It can be seen that in both cases BET areas above 500 m² g⁻¹ are achieved at acetonitrile fractions between about 0.55 and about 0.85.

Additionally, it can be seen from FIG. 13 that trends with BET area remain consistent with those predicted from theory until the maximum is reached. The inventors hypothesize that the subsequent decrease in BET area that takes place above an acetonitrile fraction of 0.75 occurs as a result of mechanical damage to individual COF particles. These particles are likely damaged as a result of the increased capillary forces exerted during drying for the monolithic bodies formed from smaller particles and that consequently possess smaller inter-particle voids. 2D COFs including TPB-DMTP-COF are known to be unstable to in-plane shear forces, suggesting that the capillary forces generated during drying may be sufficient to cause mechanical disruption of the COF pore structure.

To test whether BET areas could be further improved by use of a lower surface tension solvent, following the initial activation procedure consisting of heating the sample to 50° C. during washing in methanol, a further activation step was performed, wherein the samples were washed and dried using supercritical carbon dioxide. As capillary forces are known to be proportional to the surface tension of the in-pore fluid, the use of supercritical carbon dioxide as an ultra-low surface tension solvent was expected to result in substantially less mechanical damage to individual crystallites. FIG. 13 shows that by drying at a slow rate of 3 bar h⁻¹, BET areas can be increased to over 2,500 m² g⁻¹.

Comparison of the experimental nitrogen isotherm for the best performing scaled up monoliths (1.00 acetonitrile and 0.75 acetonitrile) with the isotherm predicted from GCMC simulations reveals excellent consistency (FIG. 14). Specifically, FIG. 14(a) shows a plot comparing the experimental nitrogen isotherm measured at 77 K for the methanol activated 0.75 acetonitrile system, the supercritical carbon dioxide activated 1.00 acetonitrile system and the theoretical nitrogen isotherm derived from GCMC simulations performed on the theoretical structure exhibiting AA interlayer stacking; FIG. 14(b) shows a semi-logarithmic plot of the same.

To investigate the effect of synthetic parameters such as catalyst concentration, starting material concentration and reaction time on monolith formation, further tests were carried out using the 0.75 (v/v) scaled up acetonitrile system (FIG. 16(a)-(c)).

With increases in catalyst concentration, a characteristic maximum was observed where monolithic bodies exhibited increasing BET areas until an upper limit, at which point BET area decreased. The inventors hypothesize that this decrease occurs as a result of a shift in the reaction equilibrium at higher concentrations of scandium ions in solution consistent with findings from previous reports^{[2] [3]} (FIG. 16(a)).

With increases in the concentration of amine, BET area was found to increase until a maximum, at which point performance plateaued and no subsequent improvements in BET area could be obtained (FIG. 16(b)).

With reaction time, BET area was found to be largely time invariant suggesting that the timescales for ordering are relatively low i.e. below 15 minutes. These results are comparable to those previously described^{[2] [4]} and suggest that it may be possible to generate the particles and agglomerates needed to form monolithic bodies in as little as 15 minutes (FIG. 16(c)).

Trends with BET area as a function of aldehyde concentration were not investigated as a result of the relatively low solubility of 2,5-dimethoxybenzene-1,4-dicarboxaldehyde in the solvent systems tested—around 1.82 g L⁻¹.

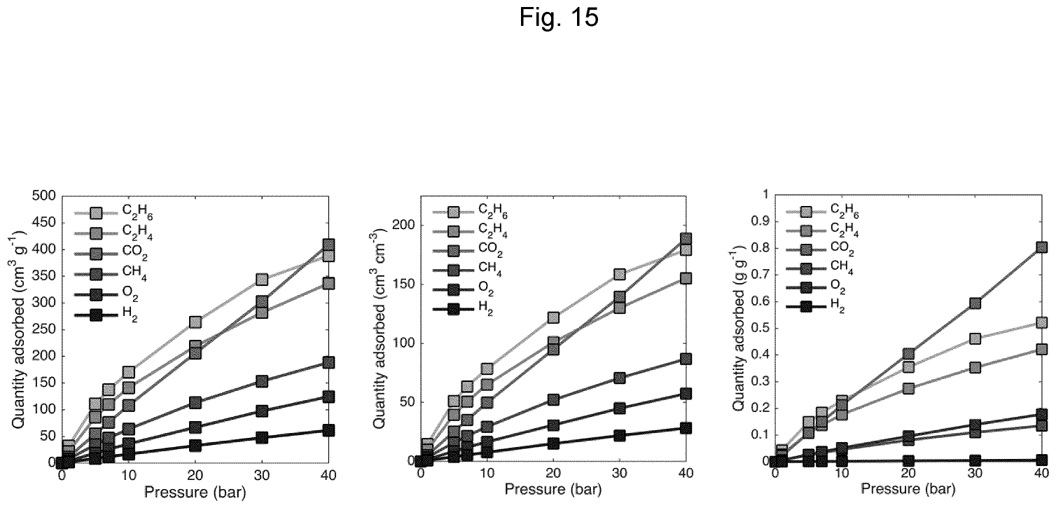

To identify analytes suitable for high pressure storage in the TPB-DMTP-COF bodies produced in these works, GCMC simulations were carried out for a variety of commercial gases of interest including methane, ethane, ethylene, carbon dioxide, oxygen and hydrogen (FIG. 15(a)-(c)).

The grand canonical Monte Carlo (GCMC) simulations were performed using the code RASPA^{[5]} to obtain nitrogen isotherms at 77 K, as well as ethane, ethylene, methane, carbon dioxide, oxygen and hydrogen isotherms at 298 K. The simulations were based on a model that included Lennard-Jones (LJ) interactions for the guest-guest and guest-host interactions. The LJ potential parameters for the framework atoms were taken from the Universal Force Field (UFF). The interactions involving nitrogen, ethane, ethylene, methane, carbon dioxide, oxygen and hydrogen were described by the TraPPE force field. Adsorbate-adsorbate and adsorbate-adsorbent van der Waals interactions were taken into account by Lorentz-Berthelot mixing rules. An atomistic representation was used for the COF, starting from CoRE COF database entry 260 (TPB-DMTPCOF). The structure was treated as rigid. The simulation cell consisted of 8 (1×1×8) unit cells with a LJ cut-off radius of 12.8 Å and no tail corrections. Coulombic interactions were calculated using Hirshfeld partial charges on the framework atoms. For carbon dioxide, oxygen and hydrogen, the long-range electrostatic interactions were handled by the Ewald summation technique. Periodic boundary conditions were applied in all three dimensions. For each state point, GCMC simulations consisted of 20,000 Monte Carlo cycles to guarantee equilibration, followed by 20,000 production cycles to calculate the ensemble averages. All simulations included insertion/deletion, translation and rotation moves with equal probabilities.

From the theoretical isotherms generated, volumetric and gravimetric storage capacities were observed to be highest for C₂ hydrocarbons and for carbon dioxide. While for pure component carbon dioxide capture at 1 bar and 298 K, with a storage capacity of 2.2 wt. %, TPB-DMTP-COF performs below leading materials such as Mg-MOF-74 (>35 wt. %), its stability to moisture, acid and base may place it among the best performing adsorbents for carbon capture under humid conditions. As TPB-DMTPCOF is one example of a wide range of COF materials having similar chemistry, it is theorised that other COF materials would provide similar or even superior performance. Indeed, it has previously been shown in literature that COFs are among the best performing materials for storage of H₂, CH₄ and CO₂^{[9]}.

Extension of Monolithic Processing to 3D COFs

To demonstrate the generalizability of our approach to the preparation of monolithic bodies from 3D COFs in addition to 2D COFs, the inventors applied similar principles to those described in the preceding section to demonstrate control over COF crystallinity and particle size in arriving at monolithic bodies from a representative 3D COF: COF-300-OMe (a methoxylated variant of COF-300). Based on the observation that the formation of monolithic COF bodies is most sensitive to the choice of reaction solvent and the catalyst concentration, a screening procedure similar to that described in the preceding section was performed.

COF-300 is known to form readily in 1,4-dioxane (also referred to as dioxane) under solvothermal conditions^{[10}]. Using this as a starting point, molar ratios of monomers were selected such that complete solubility in dioxane was ensured. Five samples employing different catalyst concentrations between 0.25 gL⁻¹ and 1.25 gL⁻¹ were then prepared and processed in a similar manner to that used to prepare TPB-DMTP-COF monoliths. A typical procedure is as follows:

To a 15 mL centrifuge tube were added tetrakis(4-aminophenyl)methane (33.31 mg, 87 μmol) and 2,5-dimethoxybenzene-1,4-dicarboxaldehyde (7.30 mg, 38 μmol). Solvent (4 mL) was then added and the mixture was sonicated briefly to a homogenous suspension. Scandium(III)trifluoromethanesulfonate (3 mg, 6 umol) was added, the tube was sealed, and the mixture was sonicated again for ca. 20 seconds. The mixture was then left to react for 30 minutes undisturbed. The sample powder was collected by centrifugation, washed with three portions of solvent (12 mL each) and an additional portion of methanol (12 mL), and was solvent exchanged in methanol (12 mL) for 24 hours. The solvent was then decanted, washed with methanol (12 mL), and left to dry at 20° C. for a further 24 hours. The monolith was dried overnight at 120° C. under vacuum prior to characterization.

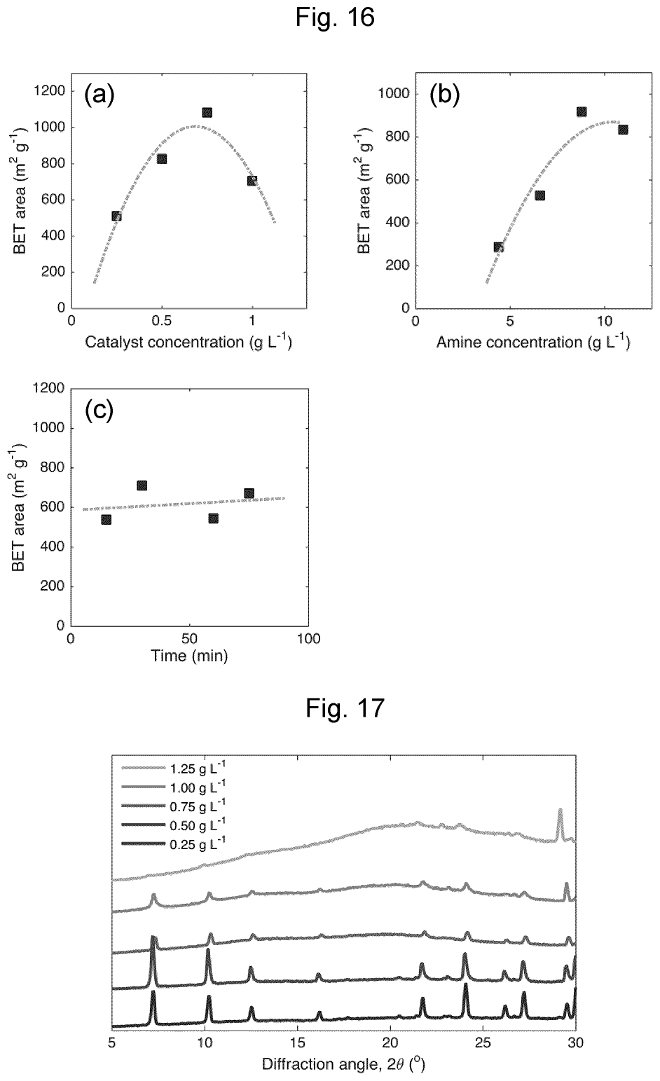

Characterization of the dried powders by PXRD revealed a maximum trend with crystallinity as previously observed, with catalyst concentrations of 0.50 g L−1 producing the most intense patterns (FIG. 17).

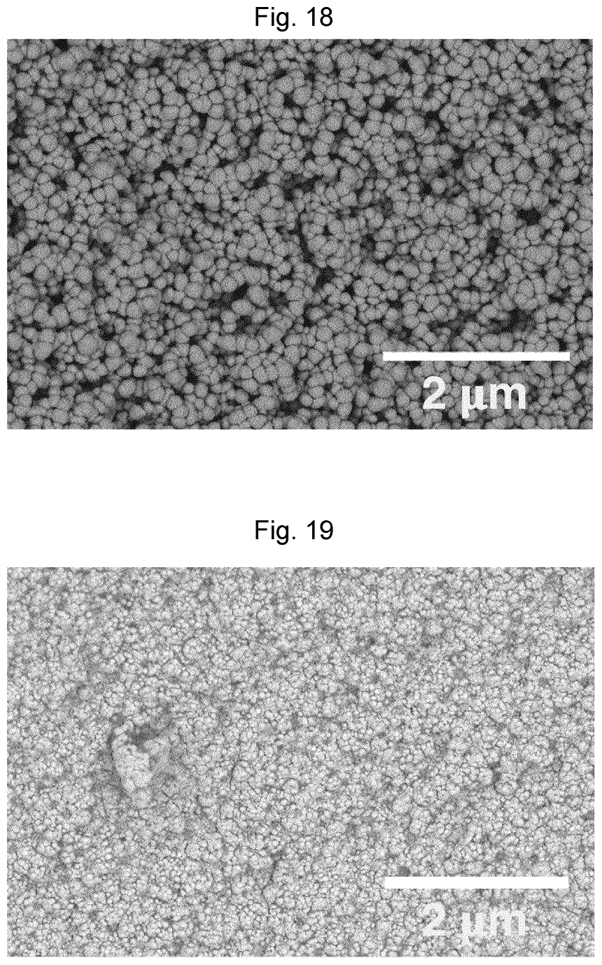

Characterization of the powder by SEM revealed, as before, a nanostructure comprising of primary particles that aggregate into larger secondary particles suggesting that similar solvent-based strategies could be used to control the degree of particle agglomeration en route to monolith body formation (FIG. 18).

A pure and mixed component solvent screen was then carried out in order to identify solvents that could be used to control the size of agglomerates.

Blends of acetone and 1,4-dioxane were found to produce monolithic bodies with the desired crystallinity. A series of samples were produced using different 1, 4-dioxane/acetone solvent systems, at a range of different catalyst concentrations. These were then characterized by SEM imaging. SEM characterization of a sample prepared in a 0.83 solution of dioxane to acetone (v/v) at a catalyst concentration of 0.50 g L⁻¹ indicates a complete disappearance of larger secondary aggregations and the emergence of a characteristic dense monolithic nanostructure comprised of primary particles and smaller secondary aggregations (FIG. 19).

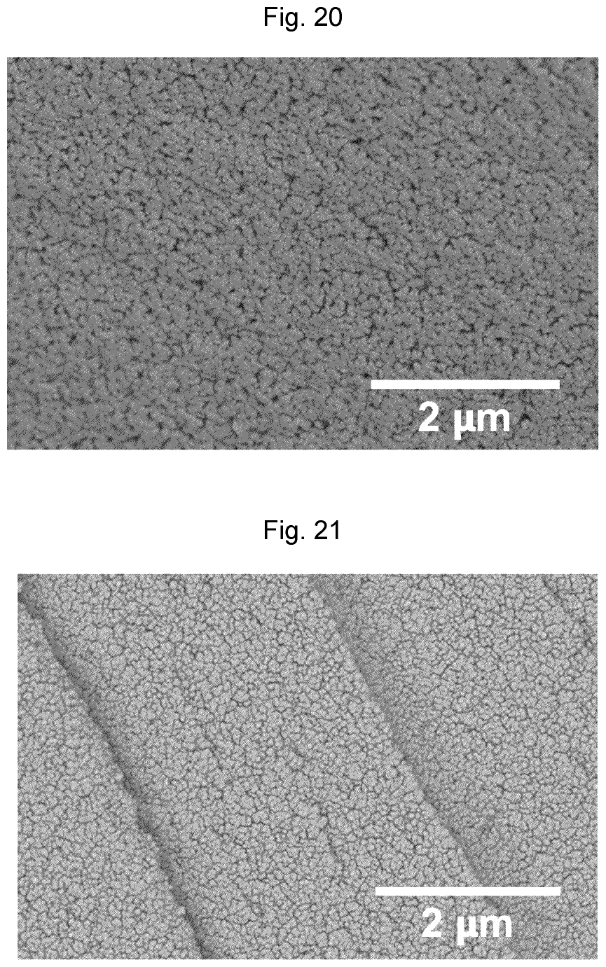

Similar results were also seen for COF-300-OMe synthesized in a 0.75 volume fraction 1,4-dioxane in acetone solvent system using a catalyst concentration of 0.50 g L⁻¹, as well as for COF-300-OMe synthesized in a 0.83 volume fraction 1,4-dioxane in acetone solvent system using catalyst concentrations of 0.75 g L⁻¹ and 0.63 g L⁻¹ (FIG. 20 and FIG. 21, respectively).

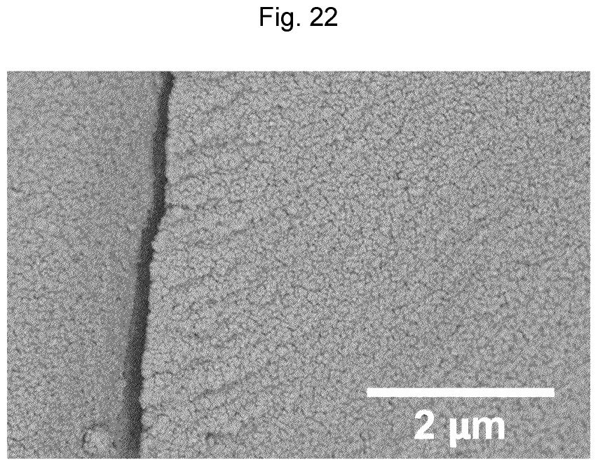

Finally, the effect of reaction time on COF-300-OMe morphology was also investigated by applying an extended reaction time of 60 minutes (in comparison to the 30 minutes reaction time of other samples) for COF-300-OMe synthesized in a 0.83 volume fraction 1,4-dioxane in acetone solvent system using a catalyst concentration of 0.50 g L⁻¹. FIG. 22.

In each of FIGS. 19 to 22, the diameters of the monolithic primary particles fall between 10 nm and 120 nm, and the dimeters of monolithic secondary particles fall between 15 nm and 250 nm. Collectively, these results indicate that similar principles used to arrive at monolithic 2D COF bodies can be easily extended to prepare monolithic 3D COF bodies.

Materials

Scandium(III)trifluoromethanesulfonate (98%) was purchased from Alfa Aesar, 1,3,5-tris(4-aminophenyl)benzene (93%) was purchased from TCI, 2,5-dimethoxybenzene-1,4-dicarboxaldehyde (97%) and tetrakis(4-aminophenyl)methane (>90%) were purchased from Sigma-Aldrich, 1-butanol (99%) and perfluorohexanes (98%) were purchased from Alfa Aesar, tetrahydrofuran (HPLC), dimethyl sulfoxide (HPLC), dimethylformamide (HPLC) and ethanol (HPLC) were purchased from Fisher Scientific, and acetone (99%), acetonitrile (99%), methanol (99%), dichloromethane (99%), 1,3,5-trimethylbenzene (99%), 1,4-dioxane (99%), chloroform (99%), 1,2-dichlorobenzene (99%), isopropanol (99%) and 1-chlorobenzene (99%) were purchased from Acros Organics. All chemicals were used as received without further purification.

General Characterisation Protocols

Powder X-ray diffraction (PXRD) patterns were recorded with a Bruker D8 diffractometer using CuKα1 (λ=1.5405 Å) radiation in Bragg Brentano parafocusing geometry with a step of 0.03° at a scan speed of 1.5 s per step. Predicted patterns were generated in Materials Studio using optimized structures obtained from the CoRE COF database.

Scanning electron microscope (SEM) images were acquired using an FEI XL30 FEGSEM with an accelerating voltage of 5 kV. Samples were sputter coated with gold.

Transmission electron microscopy (TEM) was carried out using a FEI Tecnai F20 STEM operated at 200 kV in scanning mode.

Particle size distributions were obtained using ImageJ processing software.

Nitrogen adsorption isotherms were collected at 77 K on a Micromeritics Tristar II Plus gas sorption analyzer.

BET areas were calculated using software provided by Micromeritics using Rouquerol criteria 1 & 2.

NLDFT pore-size distributions were calculated using a Micromeritics carbon slit model with a regularization parameter of 0.2.

All samples for nitrogen adsorption were degassed under vacuum at 120° C. overnight prior to analysis.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.

[1] Xu, H., Gao, J., and Jiang, D. “Stable, crystalline, porous, covalent organic frameworks as a platform for chiral organocatalysts.” Nature Chemistry 7.11 (2015): 905.

[2] Matsumoto, M., et al. “Rapid, low temperature formation of imine-linked covalent organic frameworks catalyzed by metal triflates.” Journal of the American Chemical Society 139.14 (2017): 4999-5002.

[3] Giuseppone, N., et al. “Scandium (III) catalysis of transimination reactions. Independent and constitutionally coupled reversible processes.” Journal of the American Chemical Society 127.15 (2005): 5528-5539.

[4] Li, R., et al. “Controlled growth of imine-linked two-dimensional covalent organic framework nanoparticles”, Chemical Science 10 (2019): 3796-3801.

[5] D. Dubbeldam, S. Calero, D. E. Ellis, and R. Q. Snurr, “RASPA: Molecular Simulation Software for Adsorption and Diffusion in Flexible Nanoporous Materials”, Mol. Sim 42 (2016): 81-101.

[6] Ma, J., et al. “Rapid Guest Exchange and Ultra-Low Surface Tension Solvents Optimize Metal—Organic Framework Activation.” Angewandte Chemie International Edition 56.46 (2017): 14618-14621.

[7] Moghadam, P. Z., et al. “Structure-Mechanical Stability Relations of Metal-Organic Frameworks via Machine Learning”, Matter 1.1 (2019): 219-234.

[8] Hench, L. L., and West, J. K. “The sol-gel process.” Chemical reviews 90.1 (1990): 33-72.

[9] Furukawa, H., et al. “Storage of Hydrogen, Methane, and Carbon Dioxide in Highly Porous Covalent Organic Frameworks for Clean Energy Applications” Journal of the American Chemical Society 131.25 (2009): 8875-8883.

[10] Uribe-Romo, F. J., et al. “A Crystalline Imine-Linked 3-D Porous Covalent Organic Framework” Journal of the American Chemical Society 131.13 (2009): 4570-4571.

1. A covalent-organic framework (COF) body comprising a plurality of primary COF particles, some or all of the primary COF particles being agglomerated as COF agglomerates, wherein:
the average diameter of the primary COF particles is between 10 nm and 120 nm;
the average diameter of the agglomerates is larger than the average diameter of the primary COF particles and between 15 nm and 250 nm.

2. (canceled)

3. The covalent-organic framework (COF) body according to claim 1 wherein not more than 10% of the agglomerates forming part of the covalent-organic framework (COF) body have a diameter greater than 800 nm.

4. The covalent-organic framework (COF) body according to claim 1 wherein the COF agglomerates and/or primary COF particles forming the body are formed from a single COF composition.

5. The covalent-organic framework (COF) body according to claim 1 wherein the COF agglomerates and/or primary COF particles forming the body are formed from two or more different COF compositions.

6. The covalent-organic framework (COF) body according to claim 1 wherein COF agglomerates and/or primary COF particles forming the body comprise an imine and/or a hydrazone linked COF composition.

7. The covalent-organic framework (COF) body according to claim 1 wherein the bulk density of the body is at least 80% of the calculated density of a COF single crystal of the same composition as the body.

8. The covalent-organic framework (COF) body according to claim 1 wherein the volume of the body is at least 0.5 mm³.

9. A method for manufacturing a covalent-organic framework (COF) body, comprising the steps of: providing a COF material comprising primary COF particles and agglomerates of primary COF particles, the primary COF particles having an average diameter of between 10 nm and 120 nm, the agglomerates having an average diameter of between 15 nm and 250 nm;
centrifuging a liquid suspension comprising the COF material and one or more selected solvents to form a COF concentrate; and
performing a temperature-controlled drying step to remove at least some of the solvent from the COF concentrate to thereby form the COF body.

10. The method according to claim 9 wherein the step of providing a COF material comprising primary COF particles and agglomerates of primary COF particles includes allowing the reaction of COF precursors in a reaction mix including one or more selected solvents to thereby form the particles and/or particle agglomerates of the COF material.

11. The method according to claim 10 wherein the reaction mix further comprises one or more catalysts selected from one or more of: a metal triflate; p-toluenesulfonic acid; acetic acid; benzoic acid; p-nitrobenzenesulfonic acid; benzenesulfonic acid; p-phenolsulfonic acid; trifluoroacetic acid; hydrochloroic acid; and/or sulphuric acid.

12. The method according to claim 9 wherein the one or more solvents are selected from one or more of mesitylene, 1,4-dioxane, acetonitrile, methanol, ethanol, isopropanol, n-butanol, 1,2-dichlorobenzene, 1-chlorobenzene, water, acetone, N,N-dimethylformamide, N-methyl-2-pyrrolidone, aniline, m-cresol, dimethylsulfoxide, tetrahydrofuran, toluene, chloroform, dichoromethane, xylene, tetrachloroethane, and/or trichloroethane.

13. The method according to claim 12 wherein the one or more solvents comprise acetonitrile (CH₃CN) in combination with a 1:1 (v/v) mixture of mesitylene and 1,4-dioxane.

14. The method according to claim 12 wherein the one or more solvents comprise acetone in combination with 1,4-dioxane.

15. (canceled)

16. The method according to claim 9 wherein the density of the one or more solvents is selected to be less than the calculated density of a single crystal of the COF material.

17. The method according to claim 9 wherein the absolute density difference between the one or more solvents and the calculated density of a single crystal of the COF material is >0.2 g/l.

18. The method according to claim 9 wherein the temperature-controlled drying step is performed with a maximum temperature of not more than 60° C.

19. (canceled)

20. The method according to claim 9 wherein the method includes a step of activating the COF material by washing the COF material in a suitable solvent.

21. The method according to claim 20 wherein the COF material is activated by washing the COF material in supercritical carbon dioxide.

22. The method according to claim 21 wherein the temperature-controlled drying step is performed after the step of washing the COF material in supercritical carbon dioxide, and wherein the temperature-controlled drying step is performed at a pressure release rate of from about 0.1 bar/h to about 20 bar/h.

23.-24. (canceled)

25. A gas storage system or a gas separation system comprising a gas storage vessel and a population of COF bodies according to claim 1, wherein the population of COF bodies is disposed within the gas storage vessel.
